(19) United States
(12) Patent Application Publication
(10) Pub. No.: US 2013/0103584 A1
(43) Pub. Date: Apr. 25, 2013

(54) PAYMENT SERVICE THAT PROVIDES OPTION TO AUTHENTICATE WITH EXTERNAL AUTHENTICATION SERVICE

(71) Applicants: Todd Eichner, Redondo Beach, CA (US); Corey Watts, Rossmoor, CA (US); Michael Leznik, Sherman Oaks, CA (US)

(72) Inventors: Todd Eichner, Redondo Beach, CA (US); Corey Watts, Rossmoor, CA (US); Michael Leznik, Sherman Oaks, CA (US)

(73) Assignee: PAYMINTZ, INC., Manhattan Beach, CA (US)

(21) Appl. No.: 13/281,254

(22) Filed: Oct. 25, 2011

(51) Int. Cl. G06Q 20/40

(52) U.S. Cl. 705/44

(57) ABSTRACT

A system and associated methods are disclosed for enabling users to use social media account information to make payments to merchants. A payment service receives a user's identifier in response to a user authentication request sent over a network to an authentication service of a social media site. The user authentication request includes social media login credentials of the user and is associated with a payment page of a merchant that has an account with the payment service. The payment service receives the user identifier when the authentication service validates the social media login credentials. Based at least in part on the user identifier, the payment service retrieves payment information obtained by a previous payment transaction of the user from its database. The payment service provides the user with an option to use the retrieved payment information to make a payment to the merchant.

### BACKGROUND

1. Technical Field

This disclosure relates generally to computer-implemented services for enabling merchants and other entities to collect payments from users.

2. Description of the Related Art

Consumers today routinely shop and make purchases of products and services over the Internet using web browsers. Numerous Internet merchants have set up web sites allowing customers to browse through descriptions of products and services and pay bills. After the customer has selected one or more products for purchase or has selected the payment option, Internet merchants typically provide the customer with a checkout or payment page requesting payment information from the customer. The payment information usually comprises a credit card number, expiration date, cardholder name, and any other information that may be required to authorize a charge against the customer's card. If applicable, shipping information may also be requested on the checkout page.

It is often considered an inconvenience for a customer to have to enter in the often lengthy amount of information required to process a credit card transaction each time the customer makes a payment or purchase. In some instances, the inconvenience discourages the consumer from completing the transaction.

As a consequence, a number of merchants allow the consumer to select a user ID and a password when providing payment and/or delivery information. The merchant's system retains the customer's information and associates it with the user ID and password. In this manner the customer enters her user ID and password in order to make subsequent purchases from the respective merchant. Customers typically, however, make purchase from more than one merchant. Different merchants may have different formats for a user ID and a password. Furthermore, a customer's preferred user ID may already be in use by another customer at a particular merchant. Consequently, a customer will likely have to remember several user IDs and/or passwords. Again, the inconvenience of having to remember yet another user ID and password may discourage the consumer from completing the transaction.

### BRIEF DESCRIPTION OF THE DRAWINGS

Embodiments of invention will now be described with reference to the drawings summarized below. These drawings and the associated description are provided to illustrate specific embodiments of the invention, and not to limit the scope of the invention.

FIG. 1 illustrates the principal components of an embodiment of a system that permits users to make payments to merchants.

FIG. 2 illustrates a data flow diagram showing the transfer of information between the payment service server, the credit card fulfillment service server, the authentication service server, and the consumer computer for a first transaction, according to certain embodiments.

FIG. 3 illustrates an exemplary web page displayed to the consumer before authentication for the first transaction, according to certain embodiments.

FIG. 4 illustrates an exemplary web page displayed to the consumer after authentication for the first transaction, according to certain embodiments.

FIG. 5 illustrates a data flow diagram showing the transfer of information between the payment service server, the credit card fulfillment service server, the authentication service server, and the consumer computer for a second transaction, according to certain other embodiments.

FIG. 6 illustrates an exemplary web page displayed to the consumer before authentication for the second transaction, according to certain embodiments.

FIG. 7 illustrates an exemplary web page displayed to the consumer after authentication for the second transaction, according to certain embodiments.

FIG. 8 is a flow chart illustrating a process through which a consumer has the option of using retrieved payment information to make a payment to a merchant, according to certain embodiments.

### DETAILED DESCRIPTION OF SPECIFIC EMBODIMENTS

The present invention comprises a computer-implemented payment service that enables users to use social media account information (or, in some embodiments, account information with another type of external site or service or other authentication service) to make payments to merchants. The payment service advantageously enables users to make payments to merchants (and/or other types of entities) without establishing login accounts with such merchants, and without having to create a login account with the payment service. In some embodiments, the system that hosts the payment service also hosts merchant-specific payment pages that can be accessed by users to initiate payments to the merchant. The system may also host tools for enabling merchants to create and customize their respective payment pages.

In a typical scenario, the user browses to a payment page of a merchant having an account with the payment service. The payment page includes a prompt for prompting the user to log into one or more authentication services, such as social media sites, and links to the authentication service of the one or more social media sites. From there, the user selects the option to authorize the payment with the payment service using the user's login credentials for a particular social media service. The user selects a particular social media site from the social media site selections and enters his login credentials. The selected social media site receives the login credentials and authorizes the user. The authorization service of the social media site sends to the payment service via the user's computer a valid authorization message and a unique identifier associated with the user. The payment service receives over a network the valid authorization message and the unique user identifier from the authentication service. The payment service retrieves payment information of the user from its database based at least partly on the unique user identifier received from the authentication service. The payment information was obtained by the payment service based on a previous payment transaction conducted by the user. The payment service then provides the user with an option to use the retrieved payment information to make a payment to the merchant. In an embodiment, the payment service populates the payment page with the retrieved payment information. The user verifies the payment information and submits the populated payment page to the payment service.

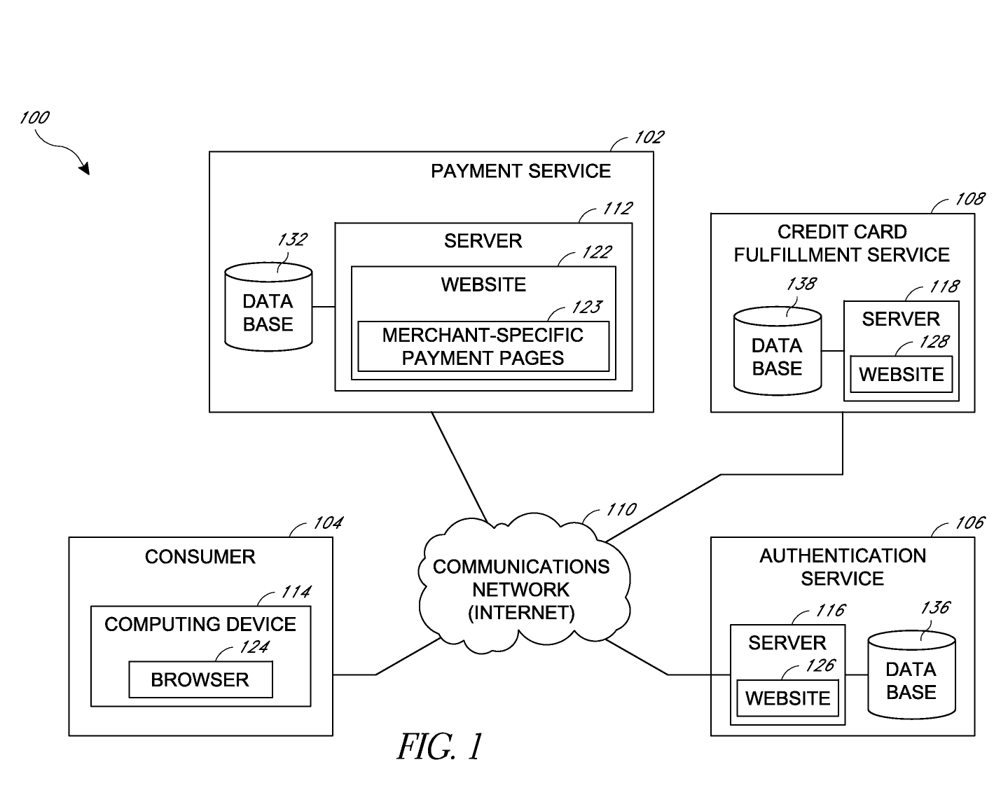

For a more detailed understanding of one embodiment of the invention, reference is first made to FIG. 1. FIG. 1 illustrates the principal components of an embodiment of a transaction system 100 that permits users to make payments to merchants. A consumer 104 can be any individual or other entity that wishes to make purchases of products or services from a merchant. In order to select and purchase products or services or make other payments, the customer preferably uses a web or mobile browser 124 running on a computing device 114. The computing device 114 can be any device that allows the consumer 104 to interact with the system 100, such as, for example, a conventional computer and modem, an interactive wireless communications device, a laptop, an iPAD, an iPhone, a smartphone, a personal digital assistant, an interactive television, a game console, or the like.

The merchant is an entity that collects payments from consumers 104. In some cases, the merchant may sell products to the consumers 104 and use the payment service to collect payments from the consumers 104. In other cases, the merchants may include service providers (e.g., fitness centers, tutoring services, etc.) that use the payment service to collect payments from the consumers 104. In other examples, the merchants may include charitable organizations that use the payment service to accept donations from consumers 104. The payments can be for a one-time transaction for the purchase of a particular good or service, or the payments can be recurring transactions, such as monthly electric company payments, monthly fitness center charges, and the like.

In order to process transactions, merchants typically require consumer information. Consumer information may include, for example, the consumer's name, the consumer's address, shipping address(es), email address, payment information, such as, for example, a credit card number, expiration date, and billing address, and the like. Typically, merchants accept credit card payments from authenticated users or consumers to increase the likelihood that the consumer information is trustworthy and decrease the likelihood of fraud. In addition to providing consumer information, the consumer 104 is often asked to provide authentication information, such as, for example, a user identification (user ID) and password. If the consumer 104 has not previously set up an account with the merchant, then the consumer 104 is further burdened with the task of setting up an account with the merchant in order to be associated with the authentication information. In some instances, the consumer 104 decides to abort the purchase rather than spend time entering consumer information, authentication information, and account information. To avoid losing sales, the merchant uses a payment service 102 to provide the authenticated consumer information to the consumer 104. The consumer 104 easily verifies the provided consumer information and verifies the payment amount or enters the payment amount before submitting the purchase.

The payment service 102 is a computer-implemented service that hosts merchant-specific payment pages 123 of registered merchants. Through these payment pages 123, consumers 104 can make online payments to the corresponding merchants using authenticated consumer information provided by the payment service 102. In one embodiment, the payment service 102 enables merchants to sell items online or to otherwise collect payments without the need to create or operate a web site.

In other embodiments, the merchant may host the payment page on a web site that it operates. In yet further embodiments, a third-party may host the payment pages.

The payment service 102 can interface with merchants and consumers 104 through a payment service web site 122 hosted by a server 112. (Each server shown in FIG. 1, including the payment service server 112, may include one or more computing devices, such as one or more physical servers.) In the embodiment illustrated in FIG. 1, the payment service web site 122 includes the merchant-specific payment pages 123. In an embodiment, the payment service 102 assigns to each payment page 123 a unique uniform resource locator (URL), such as, for example, www.payservice.com/merchantA, www.merchantA.payservice.com, or the like. The payment service server 112 accesses a payment service database 132, which stores consumer information.

The merchant is associated with the payment service 102 by, for example, subscribing to the payment service 102, having an account with the payment service 102, and the like. Individual merchants, upon enrolling online with the payment service 102, can set up one or more customized payment pages 123. These payment pages 123 can include descriptions of specific products, services, or other items that are available to consumers 104. In other cases, a merchant can set up a payment page 123 than enables consumers 104 to pay their monthly or other bills. As described above, the payment service 102 can assign to each payment page 123 a unique uniform resource locator (URL). Merchants can send out the URL for one or more payment pages 123 to their customers 104 to allow the customers to use the payment page for payments to the merchant. In other cases, the merchants can provide a link from their web sites to the payment page 123. Merchants, upon enrolling, can either enter their preexisting merchant bank account information, request that the payment service 102 set up a merchant bank account to receive the payments, use a third party master merchant account, use an Internet Payment Service Provider (ISPS) account, or the like.

To avoid having consumers 104 provide authentication information that is specific to a particular merchant, the payment service 102 prompts consumers 104 to log into an external authentication service 106 using their existing authentication information for the particular authentication service. Although a single authentication service 106 is shown, the payment service 102 may interact with multiple distinct authentication services 106 associated with multiple distinct services or sites. In an embodiment, the authentication service 106 is part of a social media service or social networking service, such as, for example, Facebook, twitter, OpenID, Google+, MySpace, Bebo, Friendster, hi5, Orkut, PerfSpot, Zorpia, Netlog, Habbo, and the like. In another embodiment, the authentication service 106 is part of a webmail service, such as for example, Gmail, AOL mail, Yahoo! Mail, Hotmail, Blue Tie, Zoho Mail, AIM Mail, Mail.com, Gawab.com, FastMail, and the like. The authentication service 106 is accessible through a web site 126, which is implemented using a server 116. The authentication service server 116 accesses an authentication service database 136, which stores authentication information for the particular authentication service. The authentication service server 116 sends to the payment service server 112 via the computing device 114 and the browser 124 a unique identifier associated with the consumer 104 when the authentication service 106 authenticates the consumer 104.

The payment service server 112 retrieves payment information associated with the unique identifier from the payment service database 132 and provides the payment information to the computing device 114 through the browser 124. The consumer 104 reviews the provided consumer information and, optionally, submits the information to make a payment to the merchant. The payment service 102 serves the payment information to a credit card fulfillment service 108.

The credit card fulfillment service 108 is preferably an entity that specializes in account processing for payments made via credit card from a credit card fulfillment web site 128, which is implemented using a server 118. The server 118 accesses fulfillment information via a fulfillment database 138. The credit card fulfillment service 108 receives the payment information, charges the consumer's credit card, and credits the merchant's account.

In the context of the present disclosure, actions indicated as being taken by the payment service 102 are preferably performed by or through, as applicable, the payment service server 112 and its associated software components. Actions indicated as being taken by the consumer 104 are preferably performed by or through, as applicable, the web or mobile browser 124 and/or the computing device 114. Actions indicated as being taken by the authentication service 106 are preferably performed by or through, as applicable, the authentication service server 116 and its associated software components. Actions indicated as being taken by the credit card fulfillment service 108 are preferably performed by or through, as applicable, the authentication service server 118 and its associated software components.

Each of the functional components shown in FIG. 1 may be implemented in program code executed by one or more general or special purpose computers. The databases 132, 136, and 138 can comprise one or more logical and/or physical data storage systems for storing data and applications used by the servers 112, 116, and 118, respectively.

The payment service server 112, the computing device 114, the authentication service server 116, and the credit card fulfillment service server 118 connect to a communications network 110, which preferably is or includes the Internet.

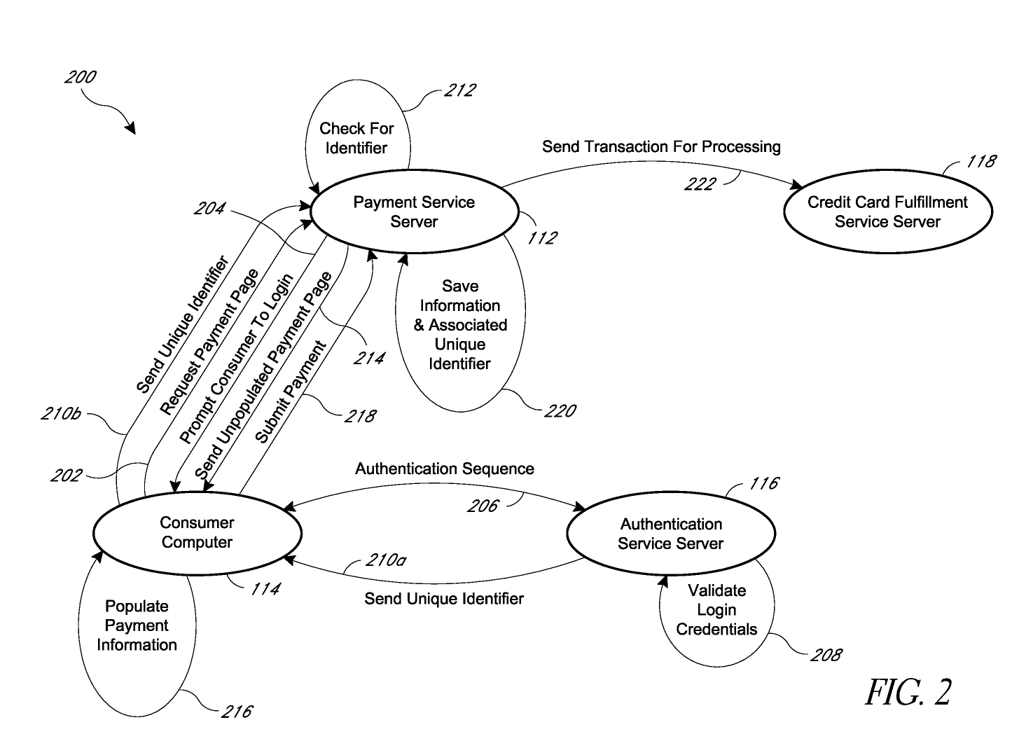

FIG. 2 illustrates an exemplary data flow diagram 200 showing the transfer of information between the payment service server 112, the consumer computer 114, the authentication service server 116, and the credit card fulfillment service server 118 for a first transaction. The first transaction is the first time the consumer 104 is making a payment through the payment service 102.

In a typical use case scenario, a consumer 104 initially accesses a merchant-specific payment page (not shown) that corresponds to a particular item that is available from the corresponding merchant. More specifically, in event 202 of FIG. 2, the consumer 104, through the browser 124 and the computing device 114 requests a payment page associated with the merchant.

In an embodiment, the payment service 102 hosts the payment page and the payment service server 112 serves the payment page to the consumer computer 114, as indicated by event 204. In another embodiment, the merchant hosts the payment page and the merchant server serves the payment page to the consumer computer 114. In yet another embodiment, a third-party entity hosts the payment page and a server of the third-party serves the payment page to the consumer computer 114.

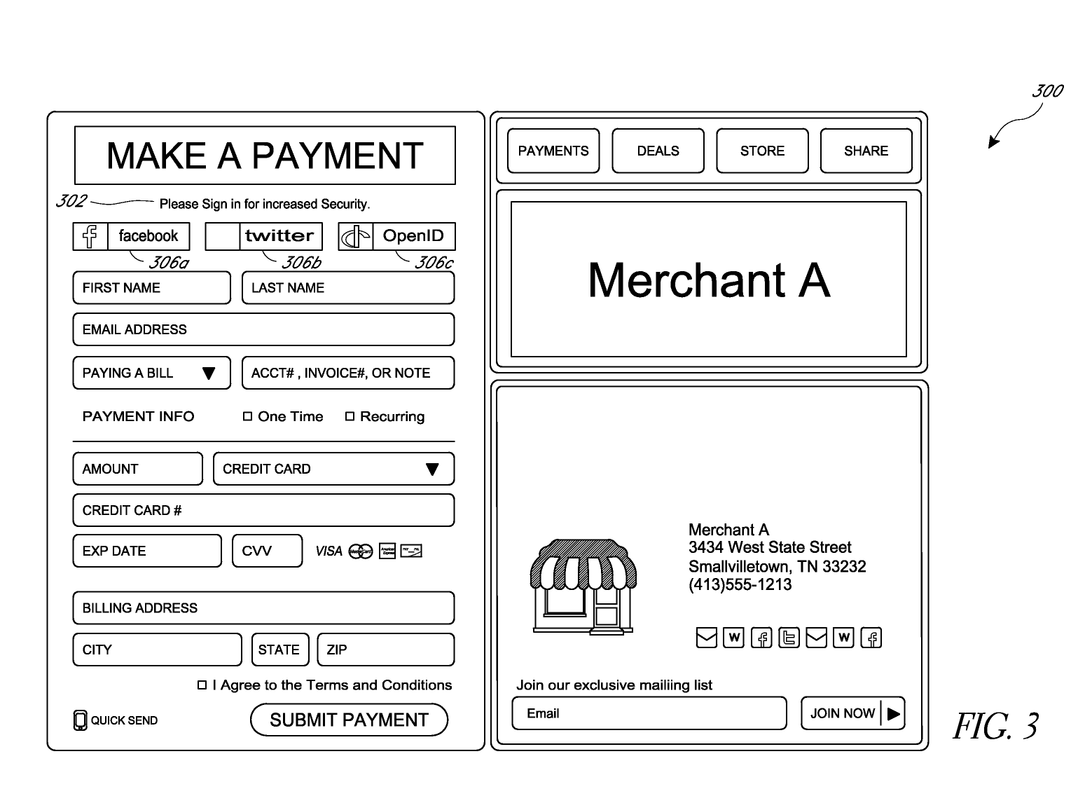

FIG. 3 illustrates an exemplary payment page 300 displayed to the consumer 104 before authentication of the first transaction. In the illustrated embodiment, Merchant A, a hypothetical merchant, serves as the Internet merchant. The payment page 300 prompts the consumer 104 to log into an external authentication site, as indicated by event 204. In the illustrated example, a prompt 302 “Please sign in for increased security” prompts the consumer 104 to select an external authentication service 106, such as a social networking service, a social media service, or a webmail service. In the illustrated example, the consumer 104 selects from one of the social networking sites, Facebook 306a, twitter 306b, and Open ID 306c.

Referring to FIG. 2, at event 206, the consumer 104 selects one of the presented external authentication services 106. The external authentication service server 116 receives the login request and the external authentication service server 116 serves the consumer computer 114 with a login page or other object through an application programming interface of the external authentication service 106. The consumer 104 enters the login information or login credentials, such as, for example, a user ID and a password, associated with the consumer 104 for the selected external authentication service 106. The external authentication service 106 validates the login credentials according to the procedure in place at the selected external authentication service 106.

In one embodiment, for example, the authentication service server 116 looks up the submitted user ID in the authentication service database 136, as indicated at event 208. If the user ID is stored in the database 136, the server 116 determines if the submitted password is the same as the password stored in the database 136 and associated with the stored user ID. If the submitted user ID is found in the database 136 and the submitted password is associated with the submitted user ID in the database 136, the authentication service 116 validates or authenticates the login credentials.

When the authentication service 116 validates the login credentials of the consumer 104, the authentication service server 116 sends a token or message indicating a valid login and at least one unique identifier associated with the valid login credentials to the payment page 300 on the consumer computer 114, as indicated at event 210a. A coding instruction, such as, for example, Javascript or the like, included in the payment page 300, instructs the browser 124 to automatically send the unique identifier to the payment service server 112. As indicated at event 210b, the browser 124 automatically sends the valid login token or message and the at least one unique identifier to the payment service server 112.

The unique identifier is associated with the valid login credentials, which are in turn associated with the consumer 104. In an embodiment, the unique identifier is distinct from the login credentials. In another embodiment, the unique identifier comprises a subset of the login credentials, such as, for example, the user ID associated with the consumer 104 at the authentication service 116. In another embodiment, the unique identifier comprises the email address associated with the login credentials. In yet another embodiment, the unique identifier comprises the name associated with the login credentials, an Internet Protocol (IP) address, device identifiers, public keys, private keys, and the like.

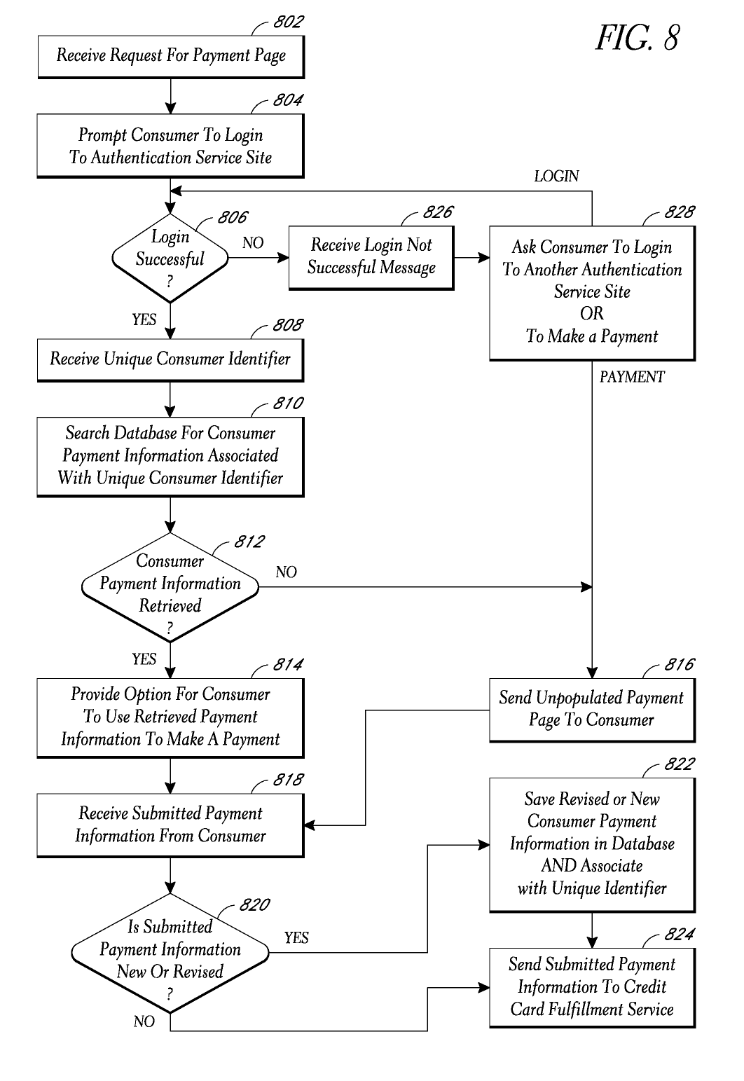

If the submitted user ID is not found in the database 136 or the submitted password is not associated with the submitted user ID in the database 136, the authentication service 106 does not validate or authenticate the login credentials. When the authentication service 106 does not validate the login credentials of the consumer 104, the authentication service server 116 sends a token or a message indicating an invalid log into the payment page 300 on the consumer computer 114. The browser 124 automatically sends the invalid login token or the invalid login message to the payment service server 112. As described below in FIG. 8, in one embodiment, the consumer 104 is given an option to log into another external authentication service 106. In another embodiment, the consumer 104 populates the payment page 300 and continues with the transaction.

For valid logins, the payment service server 112 receives the valid login token and unique identifier. At event 212, the server 112 looks up the unique identifier in the payment service database 132.

The payment service database 132 stores at least consumer information associated with the unique identifier. When the consumer 104 is making a payment via the payment service 102 for the first time, the payment service database 132 does not include consumer information associated with the unique identifier.

When the unique identifier is not found in the payment service database 132, the payment service server 112 sends an unpopulated payment page to the consumer computing device 114 through the browser 124, as indicated at event 214.

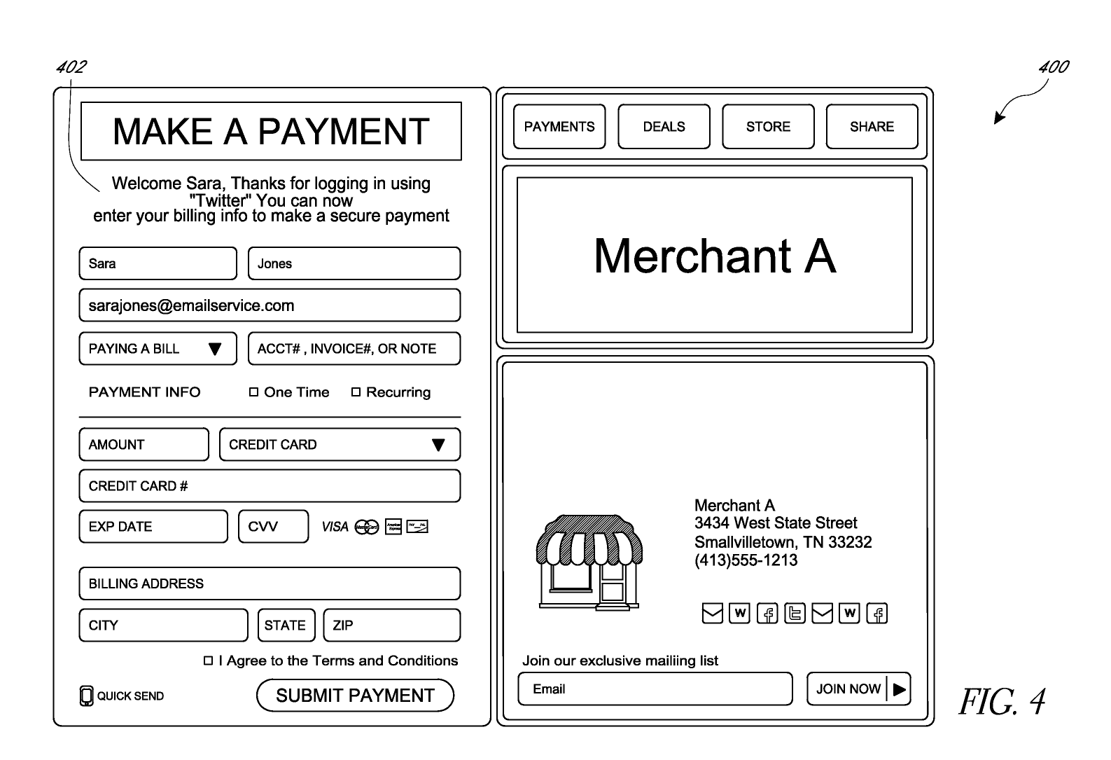

FIG. 4 illustrates an exemplary unpopulated web page 400 displayed to the consumer 104 after an unsuccessful authentication for the first transaction. The payment page 400 prompts the consumer 104 to enter his consumer information. In the illustrated example, the page 400 is personalized with the following message 402, which prompts the consumer 104 to enter consumer information: “Welcome Sara, Thanks for logging in using Twitter. You can now enter your billing information and make a secure payment.”

The payment page 400 has form entry fields for customer information, such as name and email address, type of activity, and payment information. In the illustrated embodiment, the type of activity comprises paying a bill, the associated account number, invoice number or note associated with the activity, and the like. In other embodiments, the type of activity can be paying an invoice, paying for products or services, or making a payment. In the illustrated embodiment, the payment information comprises a payment amount, a credit card brand, a credit card number, an expiration date, and the billing address of the credit card. In other embodiments, the payment page 400 includes form entry fields for a shipping address, the name on the credit card, a contact phone number, email address, and the like. To continue with the transaction, the consumer 104 enters the information, as indicated at event 216.

At event 218 of FIG. 2, the consumer submits the consumer information and the computing device 114, through the browser 124, sends the consumer information to the payment service server 112.

The payment service server 112 receives the consumer information. At event 220 of FIG. 2, the payment service server 112 saves the unique identifier and the consumer information, including the credit card number, in the database 132, and associates the unique identifier with the saved consumer information. The consumer information is now available for subsequent transactions.

At event 222 of FIG. 2, the payment service server 112 sends transaction information to the credit card fulfillment service server 118. In an embodiment, the transaction information comprises the credit card information, the payment amount, and merchant information, such as the merchant's bank account, for example. In other embodiments, the transaction information further comprises merchant ID, purchase transaction ID, or the like. In an embodiment, to complete the transaction, the credit card fulfillment service server 118 interfaces with the credit card company server to debit the payment amount from the credit card account and with the server of the financial institution associated with the merchant to credit the payment amount to the merchant account.

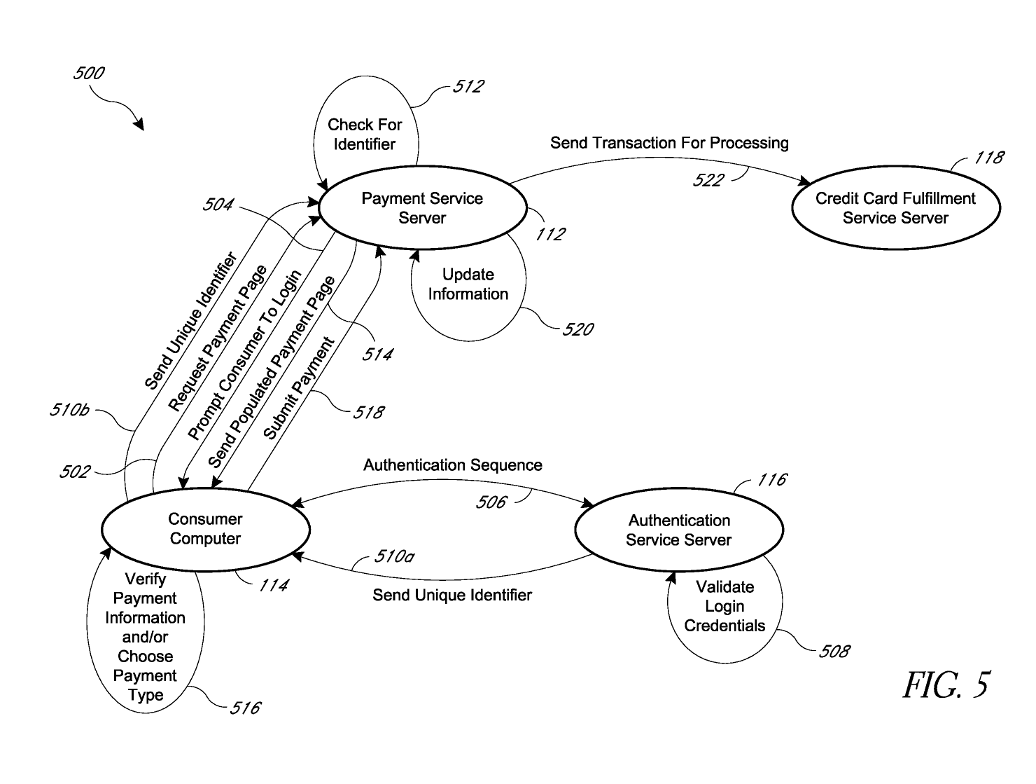

FIG. 5 illustrates an exemplary data flow diagram 500 showing the transfer of information between the payment service server 112, the consumer computer 114, the authentication service server 116, and the credit card fulfillment service server 118 for a second transaction. The second transaction is any transaction after the first transaction from the same consumer 104 as in the first transaction with any merchant that is associated with the payment service 102. In other words, the merchant in the second transaction can be the same or different from the merchant in the first transaction, as long as both merchants are associated with or have an account with the payment service 102.

Beginning with event 502, the consumer 104 through the browser 124 and the computing device 114 requests a payment page associated with the merchant.

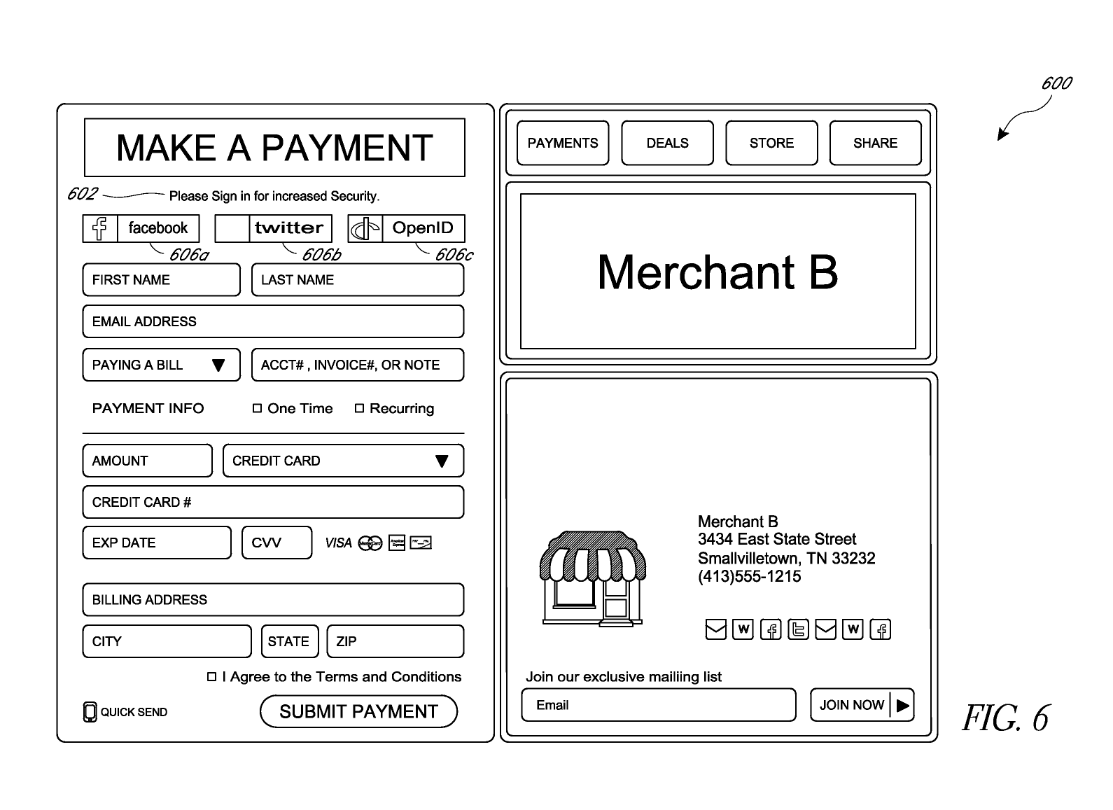

FIG. 6 illustrates an exemplary payment page 600 displayed to the consumer 104 before authentication in connection with the second transaction. In the illustrated embodiment, Merchant B, a hypothetical merchant, serves as the Internet merchant. The payment page 600 prompts the consumer 104 to log into an external authentication site, as indicated by event 504. In the illustrated example, a prompt 602 “Please sign in for increased security” prompts the consumer 104 to select an external authentication service 106, such as a social networking service, a social media service, a mobile phone number, or a webmail service. In the illustrated example, the consumer 104 selects from one of the social networking sites, Facebook 606a, twitter 606b, and OpenID 606c.

The process 500 at events 506, 508, 510a and 510b in FIG. 5 is the same as the process 200 at events 206, 208, 210a and 210b in FIG. 2, respectively. As described above with respect to event 206 of FIG. 2, the consumer 104 selects and logs into one of the presented external authentication services 106 as indicated at event 506. As described above with respect to event 208 of FIG. 2, the external authentication service 106 validates the login credentials according to the procedure in place at the selected external authentication service 106 as indicated at event 508. As described above with respect to events 210a and 210b of FIG. 2, after authentication, the authentication service server 116 sends a valid login indication and at least one unique identifier associated with the valid login to the payment page 600 via the consumer computer 114 and the browser 124, as indicated at events 510a and 510b.

For valid logins, the payment service server 112 receives the valid login token and at least one unique identifier. At event 512, the payment service server 112 searches for the unique identifier in the payment service database 132. When the unique identifier is found, the payment service server 112 retrieves the consumer information associated with the unique identifier from the payment service database 132. The payment service 102 obtains the consumer information stored in the payment service database 132 from at least one previous transaction conducted by the consumer 104 with any merchant associated with the payment service 102, such as the first transaction described above with respect to FIGS. 2, 3, and 4.

In an embodiment, as indicated at event 514, the payment service 102 provides an option for the consumer 104 to use the retrieved consumer information to make a payment to the merchant. In another embodiment, at event 514, the payment service server 112 populates the payment page with the consumer information, which includes the credit card number. In yet another embodiment, the payment service server 112 serves the computing device 114 through the browser 124 a new page including the retrieved consumer information, which includes the credit card number.

If the consumer information is not found in the payment service database 132, the payment service server 112 sends an unpopulated payment page to the consumer computing device 114 through the browser 124, as described below in FIG. 8. The consumer populates the payment page and continues with the transaction.

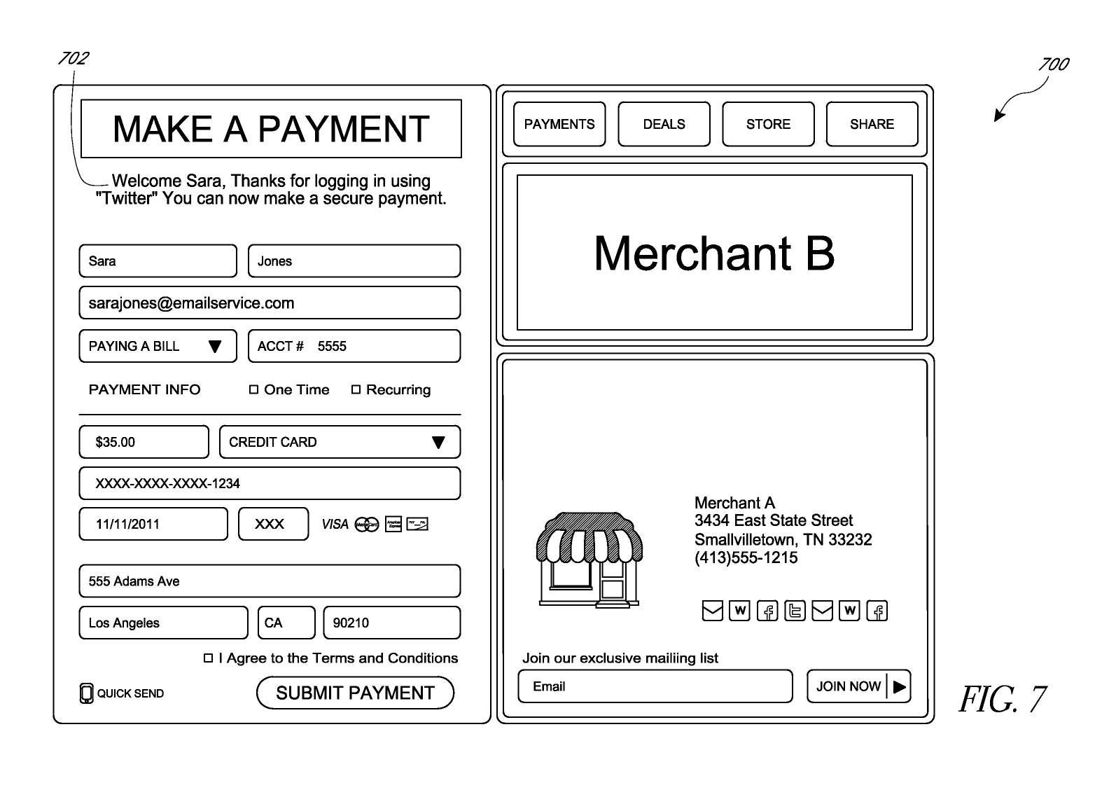

FIG. 7 illustrates an exemplary web page 700 displayed to the consumer 104 after authentication of the second transaction. The payment page 700 prompts the consumer 104 to verify the information. In one embodiment, payment page 700 includes the consumer information and the consumer 104 verifies the consumer information and enters the payment amount. In another embodiment, the server 112 supplies the consumer information, including the payment amount and the consumer 104 verifies the consumer information and the payment amount.

In the illustrated example, the page 700 is personalized with the following message 702, which prompts the consumer 104 to enter consumer information: “Welcome Sara, Thanks for logging in using Twitter. You can now enter your billing information and make a secure payment.”

The page 700 comprises populated form entry fields for customer information, such as name and email address, type of activity, and payment information. In the illustrated embodiment, the server 112 populated the consumer's name, email address, type of activity (paying a recurring bill to account number 5555), the amount to be charged to the displayed credit card number, the expiration date, and the billing address of the card. In other embodiments, other information stored in the database 132 and associated with the unique identifier, such as for example, the shipping address, the name on the credit card, the contact phone number, Geo IP locations, purchasing habits, styles, all merchants that have been shopped, other payment options such as automated clearing house (ACH), gift cards, alternative payment options, and the like, could be populated on the payment page 700.

At event 516, the consumer verifies the retrieved and populated information. In an embodiment desired, the consumer can update the information provided on the payment page 700. For example, if the consumer 104 has moved, the consumer 104 can revise the billing address associated with the credit card number. In an embodiment, when the database 132 includes more than one credit card number associated with the unique identifier, the consumer 104 chooses which credit card to use for the transaction. Further, the consumer 104 can indicates a different credit card to use for the transaction. To continue with the transaction, the consumer 104 verifies or revises the information.

At event 518, the consumer 104 submits the consumer information and the computing device 114 sends the consumer information to the payment service server 112.

The payment service server 112 receives the information. At event 520 of FIG. 5, the payment service server 112 determines whether the submitted consumer information includes any new or revised information, such as, for example, a new credit card number, a different billing address, or the like, that is not stored in the payment service database 132. If there is new and/or revised information, the payment service server 112 saves the information and associates the information with the unique identifier in the payment service database 132.

The process 500 at event 522 in FIG. 5 is the same as the process 200 at event 222 in FIG. 2. As described above with respect to event 222 of FIG. 2, the payment service server 112 sends transaction information comprising the credit card information, the payment amount, and merchant information to the credit card fulfillment service server 118, as indicated at event 522 of FIG. 5.

FIG. 8 is a flow chart illustrating a process 800 through which the consumer 104 has the option of using retrieved payment information from the payment service database 132 to make a payment to the merchant, according to an embodiment. The process 800 may be implemented in software code executed by a physical server or other computing system.

At block 802, the payment service server 112 receives a request for the payment page 300, 600 from the consumer computing device 114 through the browser 124. In another embodiment, the merchant server or a third-party entity receives the request for the payment page 300, 600.

At block 804, the payment service server 112 sends the payment page 300, 600 to the computing device 114. In other embodiments, the payment page 300, 600 is sent from the merchant server or a third-party entity server. The payment page 300, 600 prompts the consumer 104 to log into an external authentication service site 126. The external authentication service 106 is distinct from the payment service 102. A computing system 116, 126, 136 operated by the authentication service 106 is distinct from the computing system 112, 122, 132 operated by the payment service 102. In an embodiment, the external authentication service 106 is an authentication service of a social media site, a social networking site, a webmail provider, or the like.

At block 806, the payment service server 112 determines whether the login was successful. In an embodiment, the authentication service server 116 receives the login credentials from the consumer computing device 114 through the browser 124 and validates the login credentials according to the established procedure of the authentication service 106. The authentication service server 116 sends a token or other login indicator to the payment service server 112 via the computing device 114 and browser 124. The token indicates whether the login was successful and a successful login authenticates the consumer 104. Further, for a successful login, the authentication service server 116 also sends at least one unique identifier associated with the consumer 104 to the payment service server 112 via the computing device 114 and browser 124.

When the login is successful, the process 800 moves to block 808, where the payment service server 112 receives the unique consumer identifier from the authentication service server 116.

At block 810, the payment service server 112 searches the payment service database 132 for consumer information associated with the unique identifier. At block 812, the payment service server 112 determines whether consumer information associated with the unique identifier was found. If the payment service server 112 retrieves consumer information associated with the unique identifier from the database 132, the process 800 moves to block 814.

At block 814, the payment service server 112 provides the consumer 104 through the consumer computing device 114 and browser 124 the option of using the retrieved information to make a payment to the merchant. In an embodiment, the payment service server 112 populates the payment page 400, 700. In another embodiment, the payment service server 112 serves a new payment page including the consumer information to the consumer 104 through the browser 124 to the computing device 114. The consumer 104 verifies the populated consumer information, revises the information as applicable, and submits the payment page.

At block 818, the payment service server 112 receives the submitted consumer information, including the payment information, from the computing device 114.

At block 820, the payment service server 112 determines whether the submitted information includes revised or new information that was not previously stored in the payment service database 132.

If the submitted information is the same as the information retrieved from the database 132, the payment service server 112 at block 828 sends transaction information including the consumer information and the payment information to the credit card fulfillment service server 116, where the transaction is completed. In an embodiment, the credit card fulfillment service server 116 interfaces with the credit card server to debit the payment amount from the credit card account and interfaces with the server of the merchant's financial institution to credit the payment amount to the merchant account to complete the transaction.

When the login is unsuccessful at block 806, the process 800 moves to block 826, where the payment service server 112 receives an indication of the unsuccessful login from the authentication service server 116.

At block 828, the payment service server 112 sends a message to the consumer computing device 114 through the browser 124 that the login was unsuccessful and in an embodiment, gives the consumer 104 the option of logging into another authentication site 106, whose login prompt is found on the payment page 300, 600. If the consumer 104 chooses to log into another authentication service 106, the process 800 moves to block 806, where the payment service server 112 determines whether the login was successful.

At block 828, in another embodiment, the customer 104 also has the option of filling in and submitting the consumer information requested on the payment page 300, 600 to continue the transaction. If the consumer 104 chooses to enter and submit the requested information, the process moves to block 816.

When, at block 812, the payment service server 112 cannot retrieve the consumer information from the payment service database 132, the process 800 moves to block 816.

At block 816, the payment service server 112 serves an unpopulated payment page to the consumer computing device 114 through the browser 124. The consumer 104 completes and submits the requested consumer and payment information. The process 800 moves to block 818, where the payment service server 112 receives the consumer information from the computing device 114.

At block 820, as indicated above, the payment service server 112 determines whether the submitted information includes new or revised information. If the consumer information is different from the retrieved information, the process 800 moves to block 822, where the payment service server 112 saves the new/revised consumer information in the payment service database 132 and associates the new/revised information with the unique identifier.

The process 800 then moves to block 824, where the payment service server 112 sends the consumer information including the payment information as transaction information to the credit card fulfillment service server 116, where the transaction is completed as described above.

In another embodiment, rather than use an authentication service 106, the payment service 102 authenticates the consumers 104 via communications with mobile phones or other communication devices of such consumers. During the first transaction with the merchant associated with the payment service 102, the payment page prompts the consumer 104 to enter a mobile phone number of the consumer. After entering and submitting the mobile phone number, the payment service 102 sends a unique personal identification number (PIN) to the mobile phone of the consumer 104. In an embodiment, the PIN is sent via a text message, a short message service (SMS) message, a multimedia messaging service (MMS) message, an instant message, or the like. The consumer 104 enters the unique PIN into the authentication field, just like a password. The payment service 102 stores the mobile phone number in the payment service database 132 and associates the mobile phone number with the consumer information entered during the first transaction.

During any subsequent transaction with any merchant associated with the payment service 102, the payment page prompts the consumer 104 to enter the mobile phone number of the consumer. In one embodiment, the payment service 102 sends a PIN for the consumer to enter into the payment page, like a password. The payment service 102 automatically populates the secure payment information to the payment page or serves a payment page with the secure payment information populated. In another embodiment, when the consumers enters the mobile phone number a unique link is sent via SMS/text or other message to the mobile phone or mobile device. When the consumer selects/clicks the link, the payment service 102 automatically populates the secure payment information to the payment page or serves a payment page with the secure payment information populated. In this process, the payment service 102 also functions as the authentication service 106 and the mobile phone number is the unique identifier. Other aspects of this process, such as the interactions between the payment service server 112 and the consumer computer 114 and the interactions between the payment service server 112 and the credit card fulfillment server 118, are substantially the same as shown in FIGS. 2 and 5 and described above.

Depending on the embodiment, certain acts, events, or functions of any of the algorithms described herein can be performed in a different sequence, can be added, merged, or left out all together (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

All of the processes and steps described above as being implemented by the payment service may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various payment service functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A method performed by a computer-implemented payment service to enable users to use social media account information to make payments to merchants, the method comprising:
hosting a payment page of a merchant that has an account with the payment service, said payment page providing functionality for users to make payments to the merchant, said payment page comprising fields for user entry and submission of social media account log-in information;
transmitting the payment page over a network to a user computing device in response to a request received from the user computing device;
receiving, from the user computing device, social media account log-in credentials of a user, said log-in credentials submitted by the user via the payment page;
sending a user authentication request over a network to an authentication service of a social media site, said user authentication request comprising said log-in credentials of the user, said social media site being distinct from the payment service;
receiving a response from the authentication service to the user authentication request, said response including a user identifier of the user, said user identifier being distinct from the log-in credentials of the user;
retrieving payment information of the user from a database of the payment service based at least partly on the user identifier received from the authentication service, said payment information obtained by the payment service based on a previous payment transaction conducted by the user; and
providing an option for the user to use the retrieved payment information to make a payment to the merchant;
said method performed in its entirety by a computing system of the payment service.

2. The method of claim 1, wherein a computing system operated by said social media site is distinct from a computing system operated by said payment service.

3. The method of claim 1, wherein said user identifier is distinct from the social media login credentials of the user.

4. The method of claim 1, wherein said user identifier includes at least a portion of the social media login credentials of the user.

5. A method performed by a computer-implemented payment service to enable users to use social media account information to make payments to merchants, the method comprising:
receiving a user identifier of a user in response to a user authentication request sent over a network to an authentication service of a social media site, the user authentication request associated with a payment page of a merchant that has an account with a payment service, said payment page providing functionality for users to make payments to the merchant, said payment page including a user prompt for prompting the user to log into the authentication service and a link to the authentication service of at least one social media site, said user authentication request comprising social media login credentials of the user, said user identifier received when said authentication service validates said social media login credentials;
automatically retrieving payment information of the user from a database of the payment service based at least partly on the user identifier received from the authentication service, said payment information obtained by the payment service based on a previous payment transaction conducted by the user; and
providing an option for the user to use the retrieved payment information to make a payment to the merchant;
said method performed in its entirety by a computing system of the payment service.

6. The method of claim 5, wherein said user identifier is distinct from the social media login credentials of the user.

7. The method of claim 5, wherein said user identifier is distinct from the social media login credentials of the user.

8. The method of claim 5, wherein said user identifier includes at least a portion of the social media login credentials of the user.

9. The method of claim 5, further comprising populating the payment page with the retrieved payment information.

10. The method of claim 5, further comprising serving a user computing device a new page including the retrieved payment information.

11. The method of claim 5, wherein said social media site is distinct from said payment service.

12. The method of claim 5, wherein a computing system operated by said social media site is distinct from a computing system operated by said payment service.

13. The method of claim 5, further comprising:
hosting the payment page of the merchant that has the account with the payment service; and
transmitting the payment page over the network to a user computing device in response to a request received from the user computing device.

14. A payment service system of a payment service for enabling users to use social media account information to make payments to merchants, comprising:
a computer system comprising one or more computers, said computer system programmed with executable code modules to at least:
receive a user identifier of a user in response to a user authentication request sent over a network to an authentication service of a social media site, the user authentication request associated with a payment page of a merchant that has an account with a payment service, said payment page providing functionality for users to make payments to the merchant, said payment page including a user prompt for prompting the user to log into the authentication service and a link to the authentication service of at least one social media site, said user authentication request comprising social media login credentials of the user, said user identifier received when said authentication service validates said social media login credentials;
automatically retrieve payment information of the user from a database of the payment service based at least partly on the user identifier received from the authentication service, said payment information obtained by the payment service based on a previous payment transaction conducted by the user; and
provide an option for the user to use the retrieved payment information to make a payment to the merchant.

15. The payment service system of claim 14, wherein said computer system is further programmed with executable code modules to populate the payment page with the retrieved payment information.

16. The payment service system of claim 14, wherein said computer system is further programmed with executable code modules to serve a user computing device a new page including the retrieved payment information.

17. The payment service system of claim 14, wherein said social media site is distinct from said payment service.

18. The payment service system of claim 14, wherein a computer system operated by said social media site is distinct from said computer system operated by said payment service.

19. The payment service system of claim 14, wherein said computer system is further programmed with executable code modules to:
host the payment page of the merchant that has the account with the payment service; and
transmit the payment page over the network to a user computing device in response to a request received from the user computing device.

20. A non-transitory computer-readable medium having stored thereon executable code that directs a payment service computer system to perform a method to enable users to use authentication service account information to make payments to merchants that comprises:
receiving a user identifier of a user in response to a user authentication request sent over a network to an authentication service, the user authentication request associated with a payment page of a merchant that has an account with a payment service, said payment page providing functionality for users to make payments to the merchant, said payment page including a user prompt for prompting the user to log into the authentication service and a link to the authentication service, said user authentication request comprising login credentials of the user, said user identifier received when said authentication service validates said login credentials;
automatically retrieving payment information of the user from a database of the payment service based at least partly on the user identifier received from the authentication service, said payment information obtained by the payment service based on a previous payment transaction conducted by the user; and
providing an option for the user to use the retrieved payment information to make a payment to the merchant;
said payment service distinct from said authentication service.

21. The non-transitory computer-readable medium of claim 20 wherein said authentication service is an authentication service of a social media site, said login credentials are social media site login credentials, and said link is a link to the authentication service of at least one social media site.

22. The non-transitory computer-readable medium of claim 21, wherein the executable code is browser executable code.

23. The non-transitory computer-readable medium of claim 21, wherein said user identifier is distinct from the social media login credentials of the user.

24. The non-transitory computer-readable medium of claim 21, wherein said user identifier includes at least a portion of the social media login credentials of the user.

25. The non-transitory computer-readable medium of claim 21, wherein the method further comprises populating the payment page with the retrieved payment information.

26. The non-transitory computer-readable medium of claim 21, wherein the method further comprises serving a user computing device a new page including the retrieved payment information.

27. The non-transitory computer-readable medium of claim 21, wherein said social media site is distinct from said payment service.

28. The non-transitory computer-readable medium of claim 21, wherein a computing system operated by said social media site is distinct from a computing system operated by said payment service.

29. The non-transitory computer-readable medium of claim 21, wherein the method further comprises:
hosting the payment page of the merchant that has the account with the payment service; and
transmitting the payment page over the network to a user computing device in response to a request received from the user computing device.
